(19) United States
(12) Patent Application Publication
(10) Pub. No.: US 2026/0179615 A1
(43) Pub. Date: Jun. 25, 2026

(54) SYSTEM AND METHOD FOR ARTIFICIAL INTELLIGENCE AND ARTIFICIAL INTELLIGENCE-HUMAN HYBRID MODERATION

(71) Applicant: Curators of the University of Missouri, Columbia, MO (US)

(72) Inventors: Yugyung LEE, Columbia, MO (US); Ye WANG, Columbia, MO (US)

(73) Assignee: Curators of the University of Missouri, Columbia, MO (US)

(21) Appl. No.: 19/127,453

(22) PCT Filed: Nov. 8, 2023
(86) PCT No.: PCT/US2023/079031

§ 371 Date: May 6, 2025

Related U.S. Application Data
(60) Provisional application No. 63/382,768, filed on Nov. 8, 2022.

(51) Int. Cl. G10L 15/22

(52) U.S. Cl. CPC G10L 15/22

(57) ABSTRACT

A method for moderating an anonymous discussion is described. The method includes hosting the anonymous discussion among a plurality of participants and a moderator. During the anonymous discussion, the moderator is provided with contribution analysis for each of the plurality of participants, the contribution analysis indicating a participation level for the associated participant. After the anonymous discussion, each participant's contribution is analyzed to determine whether the participant has met contribution criteria. The discussion is stored as anonymized text data and can be evaluated to find topics of interest and participant sentiment.

### STATEMENT OF RELATED INVENTIONS

This application is a U.S. Nonprovisional application which claims the benefit of U.S. Provisional Application No. 63/382,768, filed Nov. 8, 2022, and is hereby incorporated by reference in its entirety.

### STATEMENT OF GOVERNMENT INTEREST

None.

### BACKGROUND

Various embodiments relate generally to moderated focus group systems, methods and computer programs and, more specifically, relate to conducting moderated focus group discussions utilizing artificial intelligence and analysis of focus group discussions.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

There is a continued need for the collection of responses in difficult conversations in our communities. Focus groups are expensive to conduct and moderate. Laws and regulations can provide penalties for collection of sensitive identifying, personal data. What is needed are systems and methods to meet these concerns and provide a viable solution.

### SUMMARY

The below summary is merely representative and non-limiting.

The above problems are overcome, and other advantages may be realized, by the use of the embodiments.

In a first aspect, an embodiment provides an artificial intelligence (AI) assisted method for moderation of discussions. The method includes hosting the anonymous discussion among a plurality of participants and a moderator. The moderator is provided with contribution analysis for each of the plurality of participants during the anonymous discussion by the AI. The contribution analysis indicates a participation level for the associated participant. After the anonymous discussion, the method includes analyzing, by the AI, each participant to determine whether the participant has met contribution criteria.

In another aspect, an embodiment provides a computer readable medium tangibly encoded with a computer program executable by a processor to perform actions of an AI assisted method for moderation of discussions. The actions include hosting the anonymous discussion among a plurality of participants and a moderator. The moderator is provided with contribution analysis for each of the plurality of participants during the anonymous discussion by the AI. The contribution analysis indicates a participation level for the associated participant. After the anonymous discussion, the actions also include analyzing, by the AI, each participant to determine whether the participant has met contribution criteria.

In a further aspect, an embodiment provides an apparatus, having one or more processors and one or more memories include computer program code. The one or more memories and the computer program code are configured to, with the one or more processors to cause the apparatus to perform actions of an AI assisted method for moderation of discussions. The actions include hosting the anonymous discussion among a plurality of participants and a moderator. The moderator is provided with contribution analysis for each of the plurality of participants during the anonymous discussion by the AI. The contribution analysis indicates a participation level for the associated participant. After the anonymous discussion, the actions also include analyzing, by the AI, each participant to determine whether the participant has met contribution criteria.

### BRIEF DESCRIPTION OF THE DRAWINGS

Aspects of the described embodiments are more evident in the following description, when read in conjunction with the attached Figures.

FIG. 1 shows a focus group session process flow in accordance with an embodiment.

FIG. 2 illustrates a moderator interface screen in accordance with an embodiment.

FIG. 3 illustrates a further moderator interface screen.

FIG. 4 shows an overview chart of the data analysis in accordance with an embodiment.

FIG. 5 shows a visualization of various topic models and themes.

FIG. 6 shows a word clouds analysis of typical words by students for a topic.

FIG. 7 shows a word clouds analysis of typical words by community for a topic.

FIG. 8 show the graph model covered by Minimal, Average, and Maximal Pooling Methods

FIG. 9 show the semantic field covered by Minimal, Average, and Maximal Pooling Methods

FIG. 10 illustrates a line-by-line analysis of sentiment and topics.

FIG. 11 is a logic flow diagram that illustrates the operation of a method, and a result of execution of computer program instructions embodied on a computer readable memory, in accordance with various embodiments.

FIG. 12 shows a simplified block diagram of devices that is are for practicing various embodiments.

### DETAILED DESCRIPTION

Various embodiments provide systems and methods for conducting moderated focus group discussions utilizing artificial intelligence. There are two modes of AI moderation: full AI moderation and AI-human moderation.
(1) AI-human moderation: The AI assists the human moderator in managing the agenda of the discussion. The AI's tasks include collecting informed consent and basic demographics, reminding the human moderator which questions have been asked, and which ones are coming up. The AI moderator also reports the participation of all participants, including accumulative word counts and the current status of each participant's response to a question. The information from the AI helps the moderator to decide the progression of the discussion. AI-human moderation mode reduces the human moderators' task of real-time conversation management and helps human moderators to focus more on conducting more in-depth conversation.
(2) AI moderation: The AI-moderator is “an empathetic listener” with domain and issue knowledge (e.g., breast cancer) to ask probing questions. The AI moderator can respond to emotional conversation with empathic responses. The AI moderator can determine whether to ask a follow-up question and what to ask based upon the ongoing conversation and domain-relevant knowledge, to gather more in-depth information. AI moderation imitates human-moderation and solves staffing and training of human moderators. The human workers can focus more on creative and critical tasks, such as research design and focus group discussion agenda planning.

Additionally, some of the systems and methods in the various embodiments focus on collection of anonymous qualitative (quantitative data) with maximal user privacy protection. Thus, collecting qualitative data on sensitive issues with users' permission becomes possible.

Several users can participate in the focus group using various devices while connected via the internet using phone, tablet, virtual reality headset or like devices. An individual response may be collected offline by using an AI enabled moderator software and the responses later uploaded for comparison and analysis. An AI along with a human moderator may be utilized to gather focus group responses to enable the human and computer process to ask further questions and illicit responses. Users may be anonymous using assigned unique names and further anonymized by retagging resulting data dissociated with the user or first assigned naming.

Users can participate in the focus group in a real time and have their image and voice anonymized. The provided system can also remove any identifying utterances with a slight delay and can be set to redact identifying responses from the recording and the written record. Users can participate in the language they are most comfortable with while, if in a group setting, the other participants may hear the response in their own language without the difficulty of accents or dialects. The deidentification of the respondent may also alleviate health care data regulatory burdens and compliance.

An embodiment provides a system for conducting artificial intelligence aided focus group discussions with anonymous participants. The system can include voice recognition and machine-translation that removes identifying traits, such as, dialect, accent, tone, pitch, and speed of speech. The system can also include deidentification from recording and written record of the focus group session.

Another embodiment provides a method for conducting focus group discussions utilizing artificial intelligence moderation. The method may include having participants download an application to a phone, computer, virtual reality device, or other device having a microphone and headset or similar capabilities. The participant is deidentified with a randomly assigned username. Additionally, the participant can be deidentified with modulation of voice. Participants responses are recorded after redaction of any identifying information. The artificial intelligence moderation may be the only form of moderation or is used in conjunction with one or more human moderators. The method may also include a participant using a tablet or other device with preloaded software to provide the moderation offline to collect participant responses.

In one, non-limiting embodiment, the system, called the WeListen system or app, is designed for anonymous remote/virtual focus group data collection as well as AI-augmented scalable text analysis. In focus group research, ensuring anonymity in focus group data collection and the assurance of participant anonymity and privacy are critical. These are factors that allow participants to express their opinions without fear of being identified or of facing potential institutional backlash. The necessity for these safeguards intensifies when dealing with sensitive or controversial social subjects.

Various embodiments provide solutions to focus group data collection and analysis used in a wide range of research on consumer insights. These systems are a solution to focus group data collection and analysis used in a wide range of research on consumer insights. They may include of two major components: 1) Data collection and 2) Data analytics.

### Part 1. Data Collection

Focus groups, a common data collection method in social science research, employ a semi-structured approach that provides flexible questioning around a set of themes. This method excels at drawing out consumer insights and contextualizing user feedback. Various embodiments may prioritize various features, such as, (1) two-step authentication for security and informed consent; (2) simple navigation for increased accessibility, (3) anonymous data collection, (4) three roles: participants, observers, and moderators; (5) assistance in moderation, (6) completion confirmation.

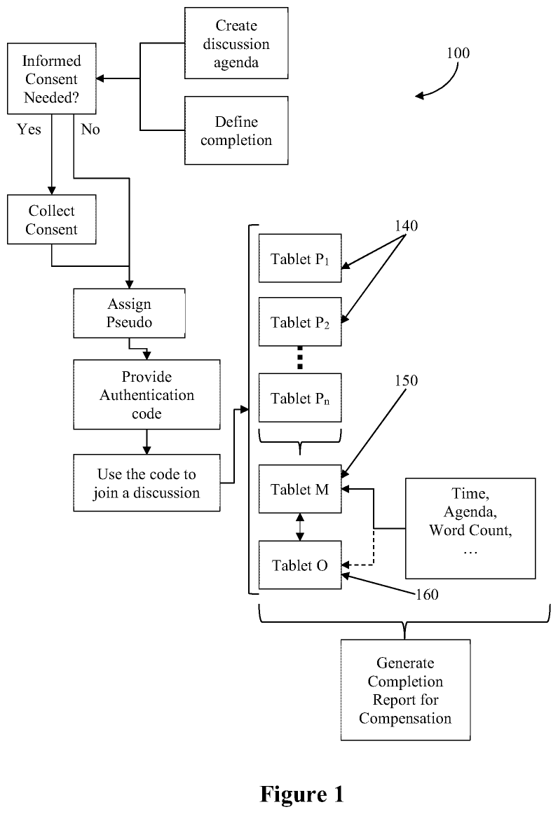

As shown in FIG. 1, shows a focus group session process flow 100. Before the session, a researcher can create an agenda and define criteria for participation completion. When it is time for the session, the system can check if informed consent is needed. If it is, the system can prompt the participant to collect the consent. On the other hand, if the consent has already been collected and/or is not required, the system can skip this step. Next, pseudo names are assigned to the participants and an authentication code sent. The participant can then use the code to join the discussion. Additionally, the system may make use of a third-party authentication service in order to help ensure participants are anonymized and access limited to those participants.

During the session, participants may comment and provide their responses using a tablet 140. A moderator may also contribute using their tablet 150. Observers can see the discussion and comment to the moderator using tablet 160. Note that in other embodiments, various devices may be used instead of tablets 140, 150, 160, for example, computers, phones, etc.

The system can track the discussion and provide analysis to the moderator and observers. This can include the amount of time the discussion has taken, how much each participant has contributed (e.g., a word count). The system may also provide an updated agenda by tracking the questions asked by the moderator.

Once the discussion is complete, the system may generate a compilation report for each participant. This may be a check that they met the completion criteria and/or may include details regarding their participation, such as, an individualized word count or word cloud. In some cases, the participant may be automatically provided compensation for their contribution based on meeting the completion criteria.

Two-step authentication and informed consent provides increased security for the participants. The system enables consumer insight research which complies with regulations and policies of human subject research. Depending upon the consenting process there are two options: (1) informed consent may be obtained prior to the focus group, in which case the user can choose to skip the consenting step; (2) the informed consent can be obtained using the system, which can be set up as the first step/prerequisite for participating in a focus group discussion. To ensure that only consented participants can join a focus group, the system can generate an authentication code for consented participants to join a discussion. The participant then provides this authentication code/meeting password to join a discussion.

The system may also provide simple navigation for increased accessibility. This minimizes technological barriers for participants who may be less tech-savvy. For instance, a participant can use a tablet with the app installed, allowing one-click access to the main navigation page. From this page, they can test speech-in and speech-out functions and access a list of scheduled focus groups to join.

Conducting anonymous focus groups is possible with the various embodiments. By using the anonymity feature, the information obtained can recorded by the investigator in such a manner that the identity of the human subjects cannot readily be ascertained, directly or through identifiers linked to the subjects.

Focus groups can be designed to use anonymous data collection, unlike traditional focus group methods where anonymity is not a guarantee. Each participant can be randomly assigned pseudo names generated by the system. This prevents the participants from using their real name or any screen names that will be associated with their identification. No video or audio recording of the session are allowed.

Participants can join the focus group from anywhere using a tablet. Their conversations can be instantly transcribed as text via speech-to-text technology and the participants is allowed to check and edit their responses before sending it to the discussion. Accordingly, the discussion will be in text format, and the text data can be saved in real time to a secured cloud database. The participants can use text-to-speech to convert responses to audio and “listen” to the conversation. This feature allows people with visual impairment to take part in the conversation. Due to at least these features, the data collection is anonymous, and the participants cannot be identified. Thus, no identifiable information will be collected.

A focus group typically has three roles: the moderator, the participants, and the observers. The app caters to these roles. Participants are the research subjects for informants. The moderator works alongside an AI assistant to manage the discussion efficiently. Moderators are generally not the researchers. Researchers/management can observe a discussion using the observer's role. This role does not provide any input to the discussion. However, it can send private messages to the moderator.

Moderation assistance may be provided, for instance, the human moderator can input focus group discussion questions via an admin interface. Once the discussion starts, the AI assistant provides real-time insights, including reminding the moderator of the next question or topic, displaying each participant's contribution (word count), timing discussions, and sending automatic reminders to less active participants. The timing and reminder functions are optional features.

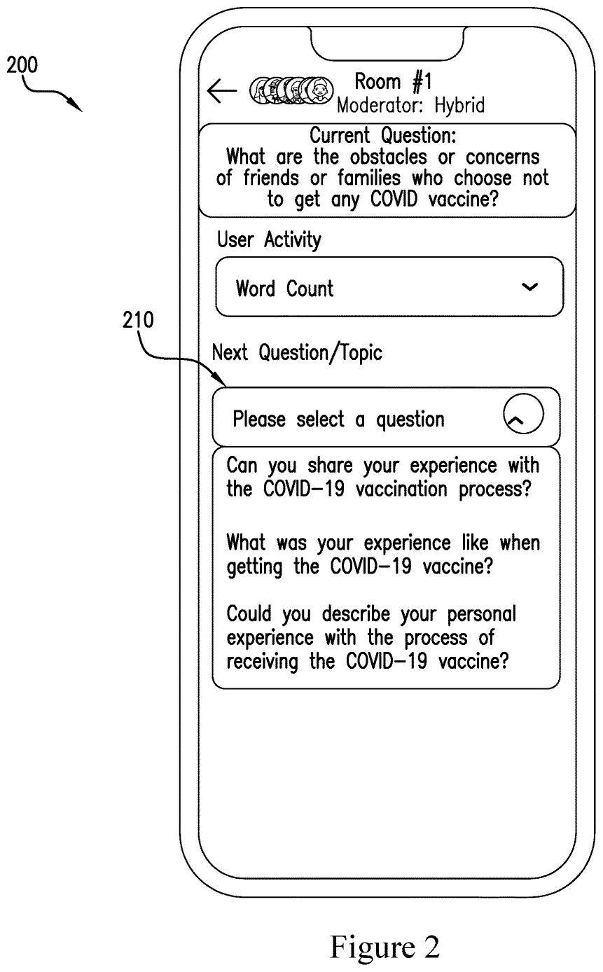

FIG. 2 shows a moderator interface screen 200 displaying several potential questions/topics 210 to be discussed. By selecting a question/topic, the system may add the selected text to the discussion.

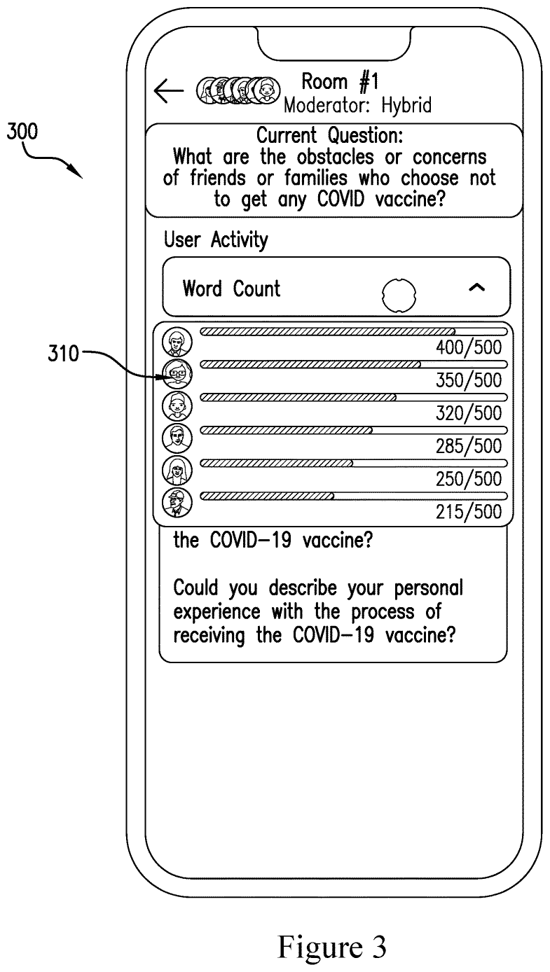

FIG. 3 shows the moderator interface screen 300 showing word counts 310 for the various participants. The word counts can be shown with a progress bar indicating how much they have contributed compared to their completion criteria. The progress bar may also be color coded for ease of understanding.

Many focus group research studies need to provide incentives to participants. The app allows users/researchers to define the criteria of completion, for example, word counts and # of questions answered. The system can automatically measure the completion of participation based on these criteria and accordingly provide a completion report for each pseudo name.

AI support can be used to deliver interpretable analytics and visualizations of text data that align with human analysts' comprehension. By processing the data the system can provide interpretable analytics for text data.

The architecture of system may encompass a mobile app front-end and a hosted back-end, such as, Firebase which can provide real-time NoSQL databases (e.g., Firestore), automatic scaling, and seamless integration with other services and third-party utilities such as Cloud Messaging, Google Cloud Console, Storage, and Google Analytics. Using a serverless architecture, facilitated by Firebase, enables shifting the server-side logic handled by NodeJS into Cloud Functions delivered via the Command Line Interface (CLI). These Cloud Functions can be automatically activated in response to HTTP requests from the client or database.

The system can utilize a cloud-based platform for mobile application development, supplemented by other services, such as, SDKs that integrate Firebase and its services. These SDKs may include native ones and programming languages such as Java, Node.js, Python, Unity, C#, and Go. For instance, incorporating Firebase with Python empowers researchers to connect their data-to-data visualization, analysis, and analytic tools for gaining in-depth insights post a focus group session. It also enables efficient querying, learning, and interpretation using prominent methods like Natural Language Processing (NLP), Machine Learning (ML), and Deep Learning (DL). The Firebase package for Unity also extends the capability to accommodate users from the extended reality (XR) ecosystem, including Augmented Reality (AR) and Virtual Reality (VR), in addition to web and mobile users.

### Part 2. Data Analysis

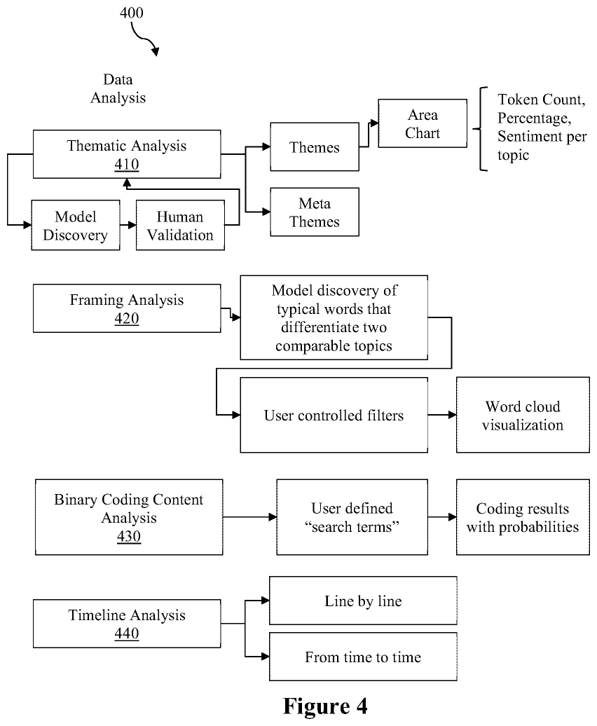

FIG. 4 shows an overview chart 400 of the data analysis. Analysis can be performed using four categories—thematic analysis 410, framing analysis 420, binary coding content analysis 430 and timeline analysis 440. Thematic analysis 410 uses model discovery and human validation to determine themes and meta-themes within the discussion. This may include an area chat analysis based on token/word count, percentage of the discussion directed to the theme, sentiment of the theme per topic, etc. Framing analysis 420 uses model discovery to find typical words that differentiate topics. This can include user controller filters and word cloud visualization. Binary coding content analysis 430 can take user defined search terms to provide probabilities signifying the relevance of a term to a category/theme. A timeline analysis 440 can provide an indication of the line-by-line themes and/or how the themes develop over time in the discussion.

FIG. 10 illustrates a line-by-line analysis 1000 of sentiment and topics. As shown, when a topic is raised in a discussion, it is listed by time (dialogue number) and given a sentiment value (positive or negative). This provides a readily understandable format.

Using automatic text analysis and visualization offers several functions.

### 1. Sentiment-Topic Cross-Category Analysis & Visualization:

Topics can be discovered via an ensemble model. Several topic models such as LDA, ChapGpt, Bart, etc. can be used to discover topics. These topics are also called themes in textual analysis. Themes are recurring and stable with supportive evidence. To ensure themes discovered are valid, common “topics” from multiple models are calculated using semantic distance measures: (1) topic words are unified in the same embedding space; (2) local distribution is smoothed using the softmax functions or a similar smoothing technique; (3) token embeddings after smoothing is aggregated into document embedding using for example average pooling or a similar method; (4) semantic distance is calculated using cosine similarity or a similar similarity measure. These themes may be given higher reliability since they recur across different topic models. Themes that are unique to a topic model can be marked with low reliability. An example:

Calculating pairwise semantic closeness between topics extracted by different topic models:
Topic 1=[(‘people’, 0.23), (‘would’, 0.10), (‘vaccination’, 0.005), (‘think’, 0.023), . . . ]
Topic 2=[(‘people’, 0.20), (‘think’, 0.14), (‘vaccine’, 0.035), (‘family’, 0.013), . . . ]
Step 1. Unify the text words in the same vector space.
Step 2. Use the distribution scores to reweight the vector representations
Step 3. Aggregate token representations into sequence representations
Step 4. Calculate the semantic distance between these two sequence representations.

For example, these two topics have a 0.999 similarity score (temperature=0.2, confidence=0.8).

Theme visualization can show the proportion of topics visualized as area charts, supported by percentages and token counts. Content of topics can visualized as topic summaries. Topic summaries are generated by a speech generation model such as GPT. The text generation uses the extracted topic words/phrases as a prompt to a speech generation function. The instruction are also given to instruct the speech generation model to output the summary in the desired format.

In human textual analysis, themes are also summarized into a meta-theme. Meta-themes are themes which acquire their meaning through the systematic co-occurrence of two or more other themes. The visualization can summarize the discovered themes into meta-themes. The techniques used to summarize the meta-theme is similar to how themes are summarize.

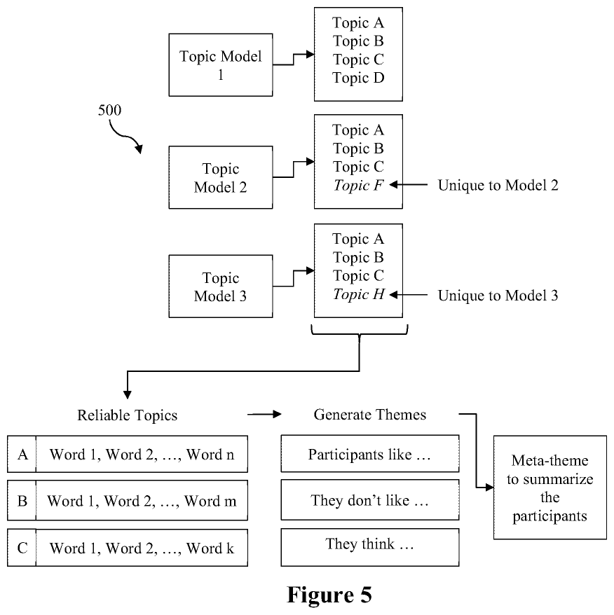

FIG. 5 shows a visualization 500 of various topic models and themes. As show, a topic model may include various topics, such as Topic Model 2 including Topic A, Topic B, Topic C and Topic F. The topics can reoccur over multiple models, or they may be unique to a Model, e.g., Topic F is unique to Model 2.

The reliable topics can be used to generate themes, such as what the participants liked or did not like. These themes can then be used to provide meta-themes which summarize the participants' opinions/sentiment.

A human user can draw a small sample of the text data to validate and modify the themes discovered. Sentiment can then be automatically measured by AI models and visualized for each topic.

Typical words of frames can be used for analysis and visualization to shows linguistic markers (common or repeated words/terms) used by participants to describe topics. Topic modeling may be used to extract topic words from different text datasets, such as various discussions. Pairwise semantic closeness may be calculated between topics extracted from different text datasets by Latent Dirichlet Allocation (LDA) topic models. This method is similar to the topic comparison in the ensemble model. For example, the following two topics from two text datasets have a 0.999 similarity score (temperature=0.2, confidence=0.8).
Community topic 1: [‘people,’ ‘would’, ‘vaccination’, ‘think’, . . . ]
Student topic 2: [‘people’, ‘think’, ‘health’, ‘vaccine,’ family, . . . ]

The system can calculate the frequency per 25,000 tokens for each word and calculate linguistic markers, words that are typical to a dataset, using the probability ratio of the word in one topic compared to the other topic, with smoothing.

A word cloud visualization may be created that includes interactive filters for human analysts, such as, (1) setting the minimal probability of a word appearing in one topic vs. another topic; (2) setting the minimal count of the words to be included in the visualization. These filters allow users to choose the most differential words with the highest frequency.

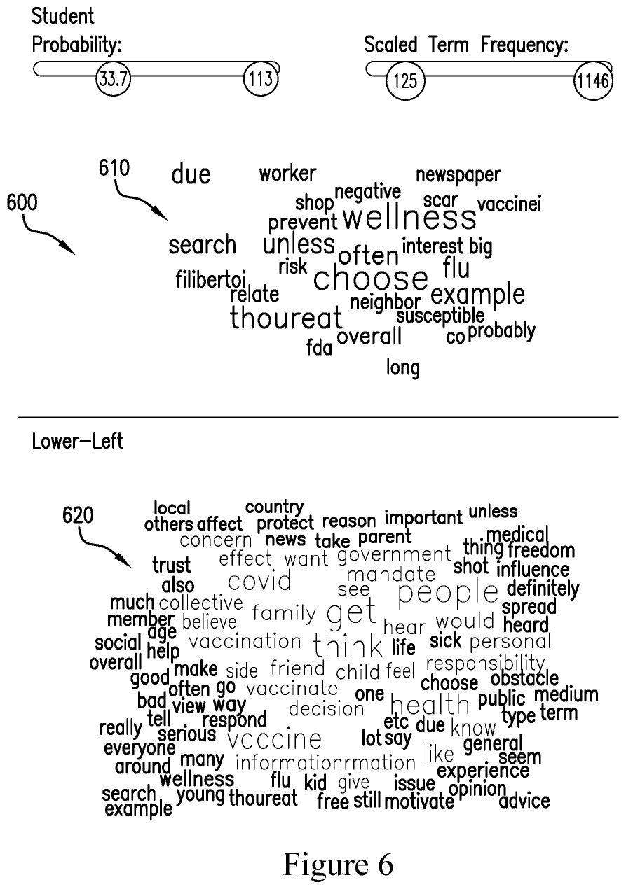

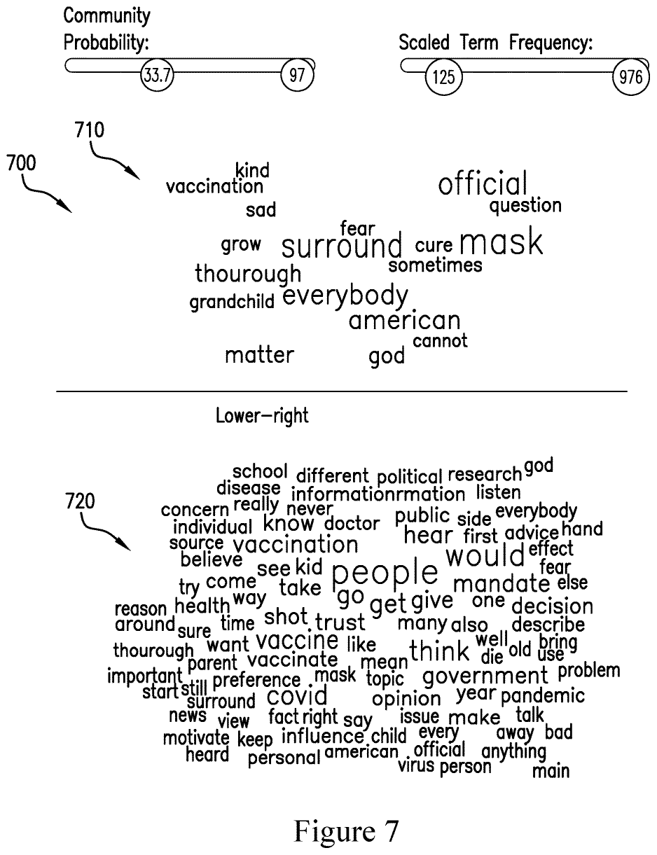

FIG. 6 shows a word clouds analysis 600 of typical words of a topic. This image shows the results for participants identified as students with linguistic markers of the student group 610 and frame of the student group 620. FIG. 7 shows another word clouds analysis 700 of typical words of a topic for community participants. The Linguistic markers for the community group 710 are shown at the top of the analysis and the frame of the community group 720 at the bottom. FIGS. 6 and 7 may be shown together to ease in review and comparison. As shown, words repeated with higher frequency are presented in larger font size compared to those with lower frequency. The words may also be color coded, for example, to emphasize repeated words, to highlight key terms, to indicate positive/negative associations, etc.

Binary content analysis and visualization can be used to show the output from an NLP model that imitates binary coding of content analysis. The content is analyzed, and the probability of each data point (a comment) containing a content feature is determined. Unlike human binary decision (0=not having the feature, 1=having the feature), this AI support provides a probability score between 0 and 1. The human analyst can decide the cut-off threshold and the optimal model depending upon a desired confidence level.

Content analysis serves as a valuable research tool to extract reliable and quantifiable content features from a wide range of textual data, and thus shedding light on their contextual implications. This emphasizes validity and reliability and ensures data accuracy and consistency throughout the analysis process. In a broad sense, content analysis encompasses two main analytical strands: manifest content and latent content. Manifest content refers to the conspicuous, surface-level elements of the data. In contrast, latent content delves deeper, investigating the underlying themes and meanings interwoven within the content.

In this continuum, manifest content-coding involves the explicit, observable facets of the data, identifiable through binary rules based on definitions. AI tools can potentially scale up content analysis, but automating manifest content coding poses significant challenges in quantifying the reliability and confidence of automatic semantic coding and compatibility with human-produced results.

To address these challenges, Natural Language Processing (NLP) models can be used to conduct automatic binary coding (presence vs. absence) following human instruction. Mathematically, the algorithms extract content features as multiple Bernoulli distributions based on cosine similarity.

Word embeddings and semantic distance are powerful tools used in language models for information retrieval and text analysis. Word embeddings are vector representations of words that enable machines to understand and capture semantic meanings, syntactic patterns, and contextual relationships. In this framework, each word is mapped to a high-dimensional vector space, and the semantic similarity or distance between words can be quantified by examining the proximity of their corresponding vectors within this space. Some models of word embeddings use techniques such as skip-gram and Continuous Bag of Words (CBOW). These models learn embeddings by predicting a word based on its context, or the converse, thereby enabling the model to comprehend the intrinsic relationships between words.

Semantic distance calculation is an application of these embeddings. By employing distance metrics like Euclidean distance or cosine similarity, the semantic closeness of words or phrases can be quantitatively gauged.

However, the field is not without challenges. Problems such as word polysemy and synonymy often present complications. To address these issues, recent efforts have focused on developing more advanced models for contextualized embeddings. These models provide dynamic embeddings based on the context of the word's use, as opposed to static embeddings, making semantic distance calculations more precise and nuanced. Consequently, these advancements have paved the way for more complex applications in NLP tasks.

One model for NLP analysis is Sentence Bidirectional Encoder Representations from Transformers (SBERT) is an extension of the BERT network, specifically designed to create semantically rich sentence embeddings. This enables the application of BERT to tasks such as large-scale semantic similarity comparison, clustering, and semantic search for information retrieval.

Large language models (LLMs) are also powerful tools for processing and analyzing textual data. These models have notably been successful in accurately and efficiently de-identifying sensitive patient information on a large scale.

Zero-shot learning exploits the predictive capacity of some tools to perform classifications on tasks that the model hasn't been explicitly trained for. Like BERT, GPT is a transformer-based language model; however, it differentiates itself by learning to “generate” context-appropriate responses. This aspect of GPT showcases the model's ability to transfer knowledge and generalize to new tasks without explicit training. As such, zero-shot learning paves the way for more flexible and adaptive AI systems by harnessing the power of pre-training and the model's grasp of the underlying data distribution. One strength of zero-shot learning is it can perform inference tasks with a limited number of examples. The limitation of this method is its learning relies heavily on the quality of the prompt that guides the model. Consequently, efforts have been undertaken to engineer high-quality prompts by both human experts and algorithms.

Various NLP models may be used which are designed to perform fuzzy match between a search phrase/term supplied by a human user and the content of text data. [symbol] represents the vector representation of the key phrase, the coding category, for instance, “family health.” [symbol] represents the vector representation of a document, such as, “The health of my kids is important to me.” As binary coding records the presence or absence of a coding category into 1 or 0, we modeled content feature extractions as multiple Bernoulli distributions based on cosine similarity. Mathematically, the cosine similarity between E′ₚ and E′ is modeled as: [Similarity, 1−Similarity], where:

$$Similarity = \frac{{\vec{E}}_{p} \cdot {\vec{E}}_{d}}{‖ {\vec{E}}_{p} ‖ ‖ {\vec{E}}_{d} ‖}$$

Optimizing cosine similarity measures presents several challenges, including (1) selecting the most suitable word embedding, (2) comparing various pooling methods that aggregate token embedding into document embedding (sentence/phrase embedding), and (3) considering zero-shot learning in the wake of GPT. Multiple models may be used, including (1) GloVe word embedding (100 and 300 dimensions) with various pooling methods (maximal, average, and minimal); (2) BERT-sentence embedding with various pooling methods (maximal and average with attention weights); and (3) Zero-shot learning using BART and ChatGPT.

The GloVe pre-trained word embedding model offers a representation of words as multi-dimensional vectors, potentially consisting of 100 or 300 dimensions. This log-bilinear variant model is trained on the non-zero entries of a global word-word co-occurrence matrix, employing a weighted least-square objective. Rather than constructing an exhaustive list of synonyms encapsulating a coding category, utilizing GloVe-based cosine similarity enables the execution of fuzzy matching, by identifying words of semantic relevancy, aiding human coders in categorizing tasks. The primary challenge is the conversion of word-level cosine similarity measures into sentence-level similarity measures.

The minimum pooling method can yield the most accurate and confident results. Minimum pooling leverages the smallest similarity score among the maximum similarity scores at the word level to signify the semantic distance at the document level. Visually, it encapsulates the smallest semantic field for fuzzy matching.

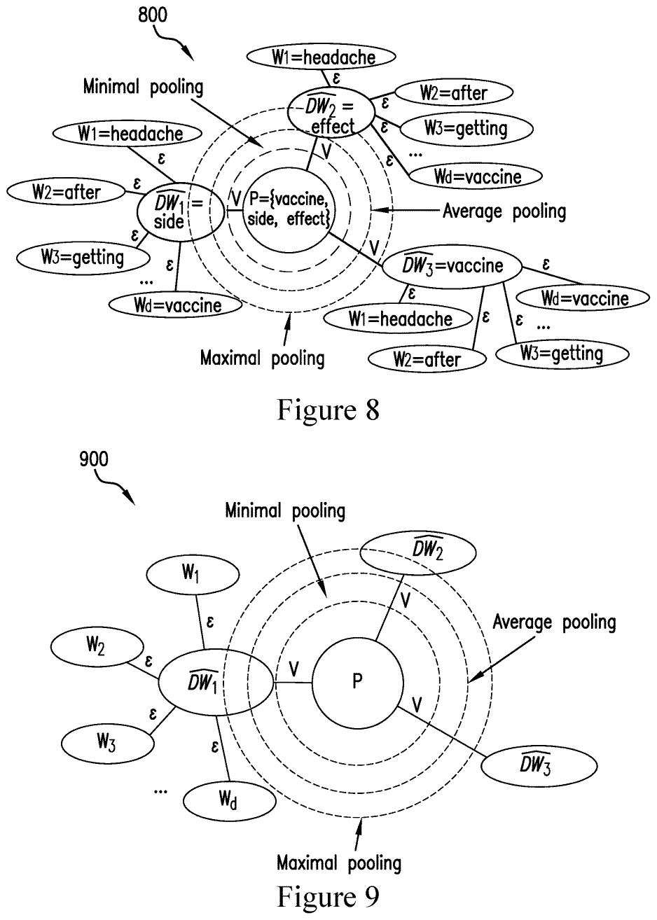

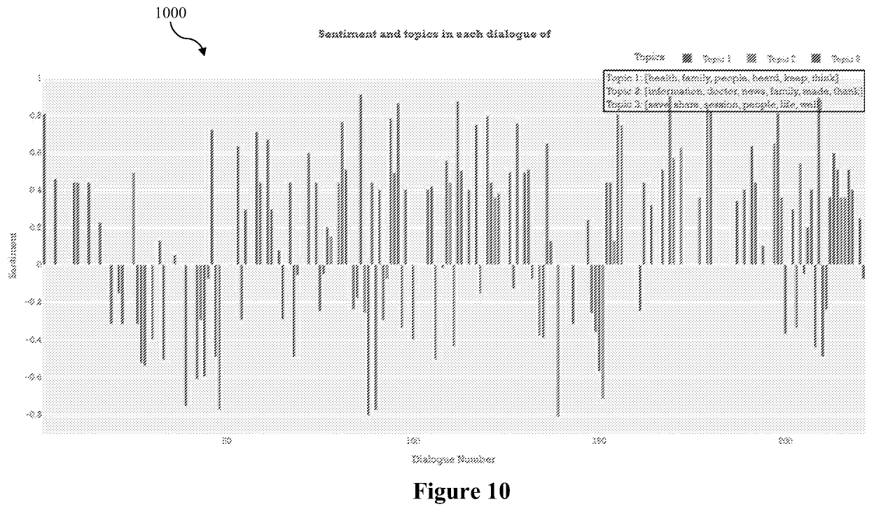

FIGS. 8 and 9 show the graph model 800 and the semantic field 900 covered by Minimal, Average, and Maximal Pooling Methods. The symbol P to represent a key phrase that describes a coding category, for example, “family health” or “side effects.” The key phrase P consists of a set of words Ŵ={Ŵ₁, Ŵ₂, Ŵ₃, . . . , Ŵₚ}, where p represents the number of words in P. Each word in P is associated with a word embedding Ê={Ê₁, Ê₂, Ê₃, . . . , Êₚ}. A document D is a text document (e.g., a comment from a participant or on social media), represented by a set of words W={W1, W2, . . . , Wd}, where d represents the number of words in D. The word embeddings for the words in D are denoted as E={E1, E2, . . . , Ed}.

The graph representation has three layers, formally noted as P=( [symbol] , V), [symbol] =(W, ε). The top layer represents the key phrase P. [symbol] ={ [symbol] , [symbol] , [symbol] , . . . , [symbol] }, p∈P, in the middle layer signifies the fuzzy matches between P and D. [symbol] connects to P via Vₙ, which represents the maximal cosine similarity score of εₙ={εₙ_{₁}, εₙ_{₂}, εₙ_{₃}, . . . , εₙ_{_{d}}}. εₙ is a set of cosine similarity scores between all tokens of a document W={W1, W2, . . . , Wd} and Ŵₙ. W in the bottom layer is connected to [symbol] via ε, formally noted as [symbol] =(W, ε). In other words, the maximal cosine similarity score between Ŵₙ and W becomes the edge feature of Vₙ. As there are p counts of V, V^{P×1} is a P-dimension maximum-score vector: V^{P×1}={V₁, V₂, . . . , Vₚ}.

Subsequently, minimal, average, and maximal pooling to V^{P×1} may be applied. The resulting pooling value, SemanticDistance, symbolizes the semantic distance between D and P. Minimal pooling uses the minimum value of V^{P×1} to denote the semantic distance between a coding category and a comment. Maximal pooling uses the maximum value of V^{P×1} to represent the semantic distance between a coding category and a comment. Average pooling leverages the average of all elements in V^{P×1} to illustrate the semantic distance between a coding category and a comment.

BERT (Bidirectional Encoder Representations from Transformers) represents a deep learning model centered around the Transformer architecture. This model is purposefully designed to comprehend the intricate relationships between words in a given text context. Its bidirectional attribute means it leverages both left and right context, where every word to the left and right of the target word is considered with the attention mechanism during pre-training. By considering the entire input sequence simultaneously, BERT embedding captures extensive contextual information. Thus, employing BERT embedding to compute the cosine similarity between P and D permits a broader contextual consideration.

Instead of performing word-level matching, BERT understands the entire sequence of P and D, measuring the semantic distance between them. BERT models comprise multiple self-attention and feed-forward neural network layers, each layer generating contextualized representations for every token in the input sequence. The key phrase P includes words \tilde{W}={Ŵ₁, Ŵ₂, Ŵ₃, . . . , Ŵₚ}, p∈P, with the final hidden states Ĥ={Ĥ₁, Ĥ₂, Ĥ₃, . . . , Ĥₚ}, p∈P, dimention_{Ĥ}=768. In a similar vein, D contains words W={W1, W2, . . . , Wd}, d∈D; H={H1, H2, . . . , Hd}, d∈D, dimention_{H}=768. H and Ĥ will then be pooled into a 768-dimension vector representation, respectively, H_{D} and Ĥ_{P}. Following this, the cosine similarity between H_{D} and Ĥ_{P} is be calculated and modeled as a Bernoulli distribution.

There are several pooling methods to aggregate token embedding into sentence-BERT embedding: (1) [CLS] pooling, (2) maximal pooling, and (3) average pooling with attention weights.

In BERT-based CLS (“classification”) pooling, the CLS token represents the entire input sequence within the BERT model. The CLS token, added to the beginning of the input sequence when employing BERT for classification tasks, is extracted in the final layer, and used as a fixed-size representation of the entire input sequence. This representation harnesses the contextual information assimilated by BERT, commonly serving as input for subsequent classification tasks. A [CLS] token is added to W as W₀. H0, dimension=768, signifies the hidden state of the [CLS] token and represents the whole sequence W. Similarly, the key phrase is pooled into Ĥ₀ of its [CLS] token.

Maximal Pooling utilizes the maximal value of the final hidden states excluding the [CLS] token. Formally, Hi=arg max H, H={H1, H2, . . . , Hd}. Ĥᵢ=argmax Ĥ, Ĥ={Ĥ₁, Ĥ₂, Ĥ₃, . . . , Ĥ_{d}}.

Average Pooling with Attention Weights computes a weighted average of the final hidden states using attention weights. Within BERT, attention weights determine how much each token contributes to representing other tokens in the sequence. The BERT-based Average pooling with attention weights for a sequence with T tokens can be represented as:

$$B E R {T}_{{Avg}_{Pooling ( H , Attention )}} = \frac{1}{T} {\sum }_{i = 1}^{T} {Atte ntion}_{i} \cdot {H}_{i}$$

Zero-shot learning is a powerful technique in the field of natural language understanding and generation. This method allows models to predict a forthcoming utterance U given a specific context C. Here, C refers to the antecedent utterance or the history of the conversation.

Significantly, the prediction of U follows a unidirectional approach, setting it apart from the bidirectional context-capture mechanism found in BERT. This means that every generated sequence serves as the conditional context for the generation of the succeeding word.

Moreover, GPT models prove particularly effective for tasks such as feature extraction or classification when they are combined with zero-shot learning, which allows them to predict class labels U based on a provided input prompt C.

Domain-specific research in content analysis categorizes text according to task and context. The models, algorithms, and visualizations presented in this study could categorize a single comment into binary decisions of being vs. not being part of different categories. These coding categories can be defined by domain experts. The inclusion of a human-in-the-loop approach can ensure the validity and reliability of model outputs intended for human decision-making.

Content features targeted by manifest content analysis often face a class-imbalance issue: the set of presence is a smaller category than the set of absence. The issue of class imbalance, therefore, demands a trade-off between precision and recall. Depending on the research objective, it can be the researcher's option to choose between different models. For instance, if precision concerning the presence of a content feature is desirable (like whether “side effect” was mentioned), a positive identification with minimal pooling might be deemed the most reliable. However, if capturing all potential cases is prioritized, zero-shot learning with average pooling can offer recommendations for positive cases. Human experts can utilize interactive data visualization to validate the model's suggestions.

Overall, when human experts work in tandem with AI models, it enables the human expert's interaction with the AI models to select the outputs based on the research needs and objectives. A human-in-the-loop approach or human-AI collaboration can yield reliable, valid, and trustworthy results for manifest content analysis.

As described above, various embodiments provide a method, apparatus and computer program(s) to moderate and analyze focus group discussions using artificial intelligence.

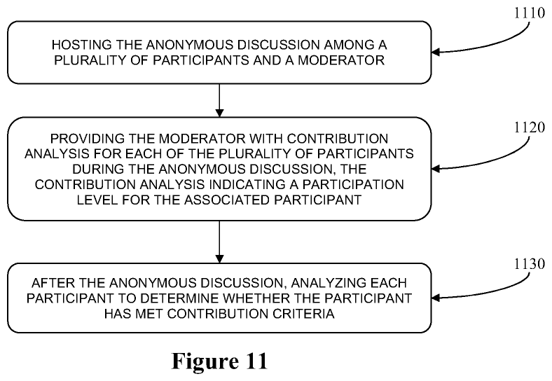

FIG. 11 is a logic flow diagram that illustrates a method, and a result of execution of computer program instructions, in accordance with various embodiments. In accordance with an embodiment a method performs, at Block 1110, a step of hosting the anonymous discussion among a plurality of participants and a moderator. At Block 1120, the method includes providing the moderator with contribution analysis for each of the plurality of participants during the anonymous discussion. The contribution analysis indicates a participation level for the associated participant, for example, as a status bar showing the percentage of participation compared to a completion criterion. At Block 1130, the method also include, after the anonymous discussion, analyzing each participant to determine whether the participant has met contribution criteria.

The various blocks shown in FIG. 11 may be viewed as method steps, as operations that result from use of computer program code, and/or as one or more logic circuit elements constructed to carry out the associated function(s).

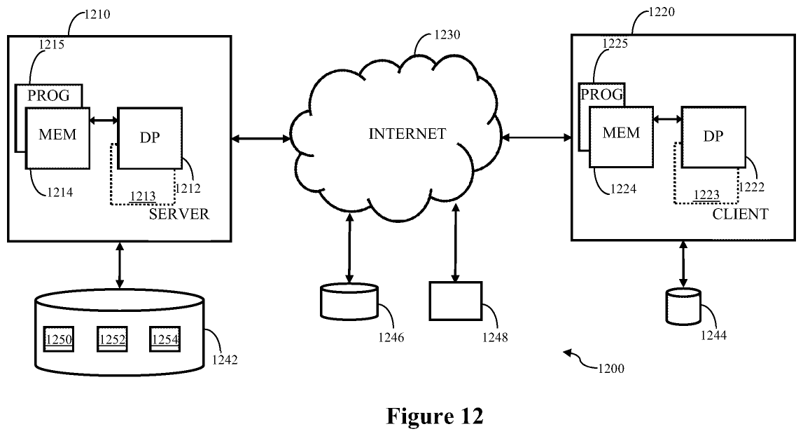

FIG. 12 shows a block diagram of a system 1200 that is suitable for use in practicing various embodiments. In the system 1200 of FIG. 12, the server 1210 includes a controller, such as a data processor (DP) 1212 and a computer-readable medium embodied as a memory (MEM) 1214 that stores computer instructions, such as a program (PROG) 1215. Server 1210 may communicate with a client 1220, for example, via the internet 1230.

Client 1220, which may provide the interface for the roles (participant, moderator, or observer), includes a controller, such as a data processor (DP) 1222 and a computer-readable medium embodied as a memory (MEM) 1224 that stores computer instructions, such as a program (PROG) 1225. Server 1210 and/or client 1220 may also include a dedicated processor, for example a speech-to-text processor 1213, 1223. Both server 1210 and/or client 1220 may communicate with third-party authentication server 1248, for example, via the internet 1230 (as shown), and/or via direct communications channels (such as a wireless connection or a physical connection).

Databases 1242, 1244, 1246 may be connected directly to the server 1210, the client 1244 or the internet 1230. As shown, database 1242 stores discussion threads 1250, participant information 1252 and participant consent 1254; however, this information may be stored separately (or together) in any of the databases 1242, 1244, 1246.

The programs 1215, 1225 may include program instructions that, when executed by the DP 1212, 1222, enable the server 1210 and/or client 1220 to operate in accordance with an embodiment. That is, various embodiments may be carried out at least in part by computer software executable by the DP 1212 of the server 1210, the DP 1222 of the client 1220, by hardware, or by a combination of software and hardware.

In general, various embodiments of the server 1210 and/or client 1220 may include tablets and computers, as well as other devices that incorporate combinations of such functions.

The MEM 1214, 1224 and databases 1242, 1244, 1246 may be of any type suitable to the local technical environment and may be implemented using any suitable data storage technology, such as magnetic memory devices, semiconductor based memory devices, flash memory, optical memory devices, fixed memory and removable memory. The DP 1212, 1222 may be of any type suitable to the local technical environment, and may include general purpose computers, special purpose computers, microprocessors and multicore processors, as non-limiting examples.

In a first embodiment, an artificial intelligence (AI) assisted method for moderation of discussions is provided. The method includes hosting the anonymous discussion among a moderator and a plurality of participants. The moderator is provided with contribution analysis for each of the plurality of participants during the anonymous discussion by the AI. The contribution analysis indicates a participation level for the associated participant. After the anonymous discussion, the method includes analyzing, by the AI, each participant to determine whether the participant has met contribution criteria.

In a further embodiment of the method above, in response to determine that a participant has met contribution criteria, payment to the participant is authorized.

In another embodiment of any one of the methods above, hosting the anonymous discussion includes, for each participant: 1) randomly generating a pseudo-name for the participant; 2) providing an authentication code to the participant; and 3) in response to receiving a request from the participant to enter the anonymous discussion having the authentication code, allowing the participant into the anonymous discussion under the pseudo-name.

In a further embodiment of any one of the methods above, hosting the anonymous discussion includes, for each participant: 1) determining whether the participant has provided informed consent; and 2) in response to determining that the participant has not provided informed consent, request informed consent from the participant.

In another embodiment of any one of the methods above, receiving an agenda for the anonymous discussion, the agenda comprising a plurality of topics; in response to determining that an individual topic has been discussed in the anonymous discussion, updating the agenda to indicate the individual topic has been met; and providing the moderator with the updated agenda during the anonymous discussion.

In a further embodiment of any one of the methods above, the contribution analysis indicating the participation level for the associated participant comprises a word count from discussion contributions by the associated participant.

In another embodiment of any one of the methods above, the contribution analysis indicating the participation level for the associated participant comprises a percentage of a total word count from discussion contributions by the associated participant compared to a target contribution criteria word count.

In a further embodiment of any one of the methods above, hosting the anonymous discussion includes receiving a speech contribution from a participant; converting the speech contribution to text using speech-to-text processing; and storing the text of the speech contribution.

In another embodiment of any one of the methods above, hosting the anonymous discussion includes: 1) receiving, at a first participant device, a text speech contribution from a second participant; 2) converting the text speech contribution to speech using text-to-speech processing; and 3) outputting of the speech on the first participant device.

In another embodiment, a computer readable medium tangibly encoded with a computer program executable by a processor to perform actions of an AI assisted method for moderation of discussions is provided. The actions include hosting the anonymous discussion among a plurality of participants and a moderator. The moderator is provided with contribution analysis for each of the plurality of participants during the anonymous discussion by the AI. The contribution analysis indicates a participation level for the associated participant. After the anonymous discussion, the actions also include analyzing, by the AI, each participant to determine whether the participant has met contribution criteria.

In a further embodiment of the computer readable medium above, in response to determine that a participant has met contribution criteria, payment to the participant is authorized.

In another embodiment of any one of the computer readable media above, hosting the anonymous discussion includes, for each participant: 1) randomly generating a pseudo-name for the participant; 2) providing an authentication code to the participant; and 3) in response to receiving a request from the participant to enter the anonymous discussion having the authentication code, allowing the participant into the anonymous discussion under the pseudo-name.

In a further embodiment of any one of the computer readable media above, hosting the anonymous discussion includes, for each participant: 1) determining whether the participant has provided informed consent; and 2) in response to determining that the participant has not provided informed consent, request informed consent from the participant.

In another embodiment of any one of the computer readable media above, receiving an agenda for the anonymous discussion, the agenda comprising a plurality of topics; in response to determining that an individual topic has been discussed in the anonymous discussion, updating the agenda to indicate the individual topic has been met; and providing the moderator with the updated agenda during the anonymous discussion.

In a further embodiment of any one of the computer readable media above, the contribution analysis indicating the participation level for the associated participant comprises a word count from discussion contributions by the associated participant.

In another embodiment of any one of the computer readable media above, the contribution analysis indicating the participation level for the associated participant comprises a percentage of a total word count from discussion contributions by the associated participant compared to a target contribution criteria word count.

In a further embodiment of any one of the computer readable media above, hosting the anonymous discussion includes receiving a speech contribution from a participant; converting the speech contribution to text using speech-to-text processing; and storing the text of the speech contribution.

In another embodiment of any one of the computer readable media above, hosting the anonymous discussion includes: 1) receiving, at a first participant device, a text speech contribution from a second participant; 2) converting the text speech contribution to speech using text-to-speech processing; and 3) outputting of the speech on the first participant device.

In another embodiment of any one of the computer readable media above, the computer readable medium is a non-transitory computer readable medium (e.g., CD-ROM, RAM, flash memory, etc.).

In a further embodiment of any one of the computer readable media above, the computer readable medium is a storage medium.

In a further embodiment, an apparatus, having one or more processors and one or more memories include computer program code is provided. The one or more memories and the computer program code are configured to, with the one or more processors to cause the apparatus to perform actions of an AI assisted method for moderation of discussions. The actions include hosting the anonymous discussion among a plurality of participants and a moderator. The moderator is provided with contribution analysis for each of the plurality of participants during the anonymous discussion by the AI. The contribution analysis indicates a participation level for the associated participant. After the anonymous discussion, the actions also include analyzing, by the AI, each participant to determine whether the participant has met contribution criteria.

In a further embodiment of the apparatus above, in response to determine that a participant has met contribution criteria, payment to the participant is authorized.

In another embodiment of any one of the apparatus above, hosting the anonymous discussion includes, for each participant: 1) randomly generating a pseudo-name for the participant; 2) providing an authentication code to the participant; and 3) in response to receiving a request from the participant to enter the anonymous discussion having the authentication code, allowing the participant into the anonymous discussion under the pseudo-name.

In a further embodiment of any one of the apparatus above, hosting the anonymous discussion includes, for each participant: 1) determining whether the participant has provided informed consent; and 2) in response to determining that the participant has not provided informed consent, request informed consent from the participant.

In another embodiment of any one of the apparatus above, receiving an agenda for the anonymous discussion, the agenda comprising a plurality of topics; in response to determining that an individual topic has been discussed in the anonymous discussion, updating the agenda to indicate the individual topic has been met; and providing the moderator with the updated agenda during the anonymous discussion.

In a further embodiment of any one of the apparatus above, the contribution analysis indicating the participation level for the associated participant comprises a word count from discussion contributions by the associated participant.

In another embodiment of any one of the apparatus above, the contribution analysis indicating the participation level for the associated participant comprises a percentage of a total word count from discussion contributions by the associated participant compared to a target contribution criteria word count.

In a further embodiment of any one of the apparatus above, hosting the anonymous discussion includes receiving a speech contribution from a participant; converting the speech contribution to text using speech-to-text processing; and storing the text of the speech contribution.

In another embodiment of any one of the apparatus above, hosting the anonymous discussion includes: 1) receiving, at a first participant device, a text speech contribution from a second participant; 2) converting the text speech contribution to speech using text-to-speech processing; and 3) outputting of the speech on the first participant device.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method for moderating an anonymous discussion, the method comprising:
hosting the anonymous discussion among a plurality of participants and a moderator,
providing the moderator with contribution analysis for each of the plurality of participants during the anonymous discussion, the contribution analysis indicating a participation level for the associated participant; and
after the anonymous discussion, analyzing each participant to determine whether the participant has met contribution criteria.

2. The method of claim 1, further comprising: in response to determine that a participant has met contribution criteria, authorizing payment to the participant.

3. The method of claim 1, wherein hosting the anonymous discussion comprises, for each participant:
randomly generating a pseudo-name for the participant;
providing an authentication code to the participant; and
in response to receiving a request from the participant to enter the anonymous discussion having the authentication code, allowing the participant into the anonymous discussion under the pseudo-name.

4. The method of claim 1, wherein hosting the anonymous discussion comprises, for each participant:
determining whether the participant has provided informed consent; and
in response to determining that the participant has not provided informed consent, request informed consent from the participant.

5. The method of claim 1, further comprising:
receiving an agenda for the anonymous discussion, the agenda comprising a plurality of topics;
in response to determining that an individual topic has been discussed in the anonymous discussion, updating the agenda to indicate the individual topic has been met; and
providing the moderator with the updated agenda during the anonymous discussion.

6. The method of claim 1, wherein the contribution analysis indicating the participation level for the associated participant comprises a word count from discussion contributions by the associated participant.

7. The method of claim 1, wherein the contribution analysis indicating the participation level for the associated participant comprises a percentage of a total word count from discussion contributions by the associated participant compared to a target contribution criteria word count.

8. The method of claim 1, wherein hosting the anonymous discussion comprises:
receiving a speech contribution from a participant;
converting the speech contribution to text using speech-to-text processing; and
storing the text of the speech contribution.

9. The method of claim 1, wherein hosting the anonymous discussion comprises:
receiving, at a first participant device, a text speech contribution from a second participant;
converting the text speech contribution to speech using text-to-speech processing; and
outputting of the speech on the first participant device.

10. The method of claim 9, wherein converting the text speech contribution to speech further comprises translating the speech from a first language to a second language.

11. A computer readable medium tangibly encoded with a computer program executable by a processor to perform actions for moderating an anonymous discussion, the actions comprising:
hosting the anonymous discussion among a plurality of participants and a moderator,
providing the moderator with contribution analysis for each of the plurality of participants during the anonymous discussion, the contribution analysis indicating a participation level for the associated participant; and
after the anonymous discussion, analyzing each participant to determine whether the participant has met contribution criteria.

12. The computer readable medium of claim 11, the actions further comprising: in response to determine that a participant has met contribution criteria, authorizing payment to the participant.

13. The computer readable medium of claim 11, wherein hosting the anonymous discussion comprises, for each participant:
randomly generating a pseudo-name for the participant;
providing an authentication code to the participant; and
in response to receiving a request from the participant to enter the anonymous discussion having the authentication code, allowing the participant into the anonymous discussion under the pseudo-name.

14. The computer readable medium of claim 11, the actions further comprising:
receiving an agenda for the anonymous discussion, the agenda comprising a plurality of topics;
in response to determining that an individual topic has been discussed in the anonymous discussion, updating the agenda to indicate the individual topic has been met; and
providing the moderator with the updated agenda during the anonymous discussion.

15. The computer readable medium of claim 11, wherein the contribution analysis indicating the participation level for the associated participant comprises a word count from discussion contributions by the associated participant.

16. An apparatus for moderating an anonymous discussion, the apparatus comprising at least one processor; and at least one memory including computer program code, the at least one memory and the computer program code configured to, with the at least one processor, cause the apparatus to perform at least the following:
to host the anonymous discussion among a plurality of participants and a moderator,
to provide the moderator with contribution analysis for each of the plurality of participants during the anonymous discussion, the contribution analysis indicating a participation level for the associated participant; and
after the anonymous discussion, to analyze each participant to determine whether the participant has met contribution criteria.

17. The apparatus of claim 16, the at least one memory and the computer program code are further configured to cause the apparatus, in response to determine that a participant has met contribution criteria, to authorize payment to the participant.

18. The apparatus of claim 16, the at least one memory and the computer program code are further configured to cause the apparatus, when hosting the anonymous discussion, for each participant:
to randomly generate a pseudo-name for the participant;
to provide an authentication code to the participant; and
in response to receiving a request from the participant to enter the anonymous discussion having the authentication code, to allow the participant into the anonymous discussion under the pseudo-name.

19. The apparatus of claim 16, the at least one memory and the computer program code are further configured to cause the apparatus:
to receive an agenda for the anonymous discussion, the agenda comprising a plurality of topics;
in response to determining that an individual topic has been discussed in the anonymous discussion, to update the agenda to indicate the individual topic has been met; and
to provide the moderator with the updated agenda during the anonymous discussion.

20. The apparatus of claim 16, wherein the contribution analysis indicating the participation level for the associated participant comprises a word count from discussion contributions by the associated participant.
